(19) United States
(12) Patent Application Publication
(10) Pub. No.: US 2020/0318665 A1
(43) Pub. Date: Oct. 8, 2020

(54) BUTTING STRUCTURE AND ASSEMBLING METHOD THEREOF

(71) Applicant: CHICONY POWER TECHNOLOGY CO., LTD., New Taipei City (TW)

(72) Inventor: Wen-Yung LU, New Taipei City (TW)

(21) Appl. No.: 16/422,418

(22) Filed: May 24, 2019

(30) Foreign Application Priority Data
Apr. 3, 2019 (TW) 108111858

(51) Int. Cl. F16B 5/00; F16B 3/00; F16B 4/00; F16B 5/07

(52) U.S. Cl. CPC F16B 5/0036; F16B 5/07; F16B 4/004; F16B 3/005

(57) ABSTRACT

A butting structure includes a first connecting portion disposed on the inner surface of a first object and a second connecting portion disposed on the inner surface of a second object. A leading angle is provided at the junction of a top surface and a first side of the first connecting portion. An accommodation space is defined between the top surface and the inner surface of the first object. The second connecting portion includes a bump and a horn structure. The bump is connected to the second object and is disposed corresponding to the accommodation space. The horn structure is connected to the second object and is disposed corresponding to the first connecting portion. A first gap is provided between the bump and the horn structure. An assembling method of the butting structure is also provided.

### CROSS REFERENCE TO RELATED APPLICATIONS

This Non-provisional application claims priority under 35 U.S.C. § 119(a) on Patent Application No(s). 108111858 filed in Taiwan, Republic of China on Apr. 3, 2019, the entire contents of which are hereby incorporated by reference.

### BACKGROUND

### Technology Field

The present disclosure relates to a butting structure and an assembling method thereof. In particular, the present disclosure relates to a butting structure for fixing a first object and a second object, which are disposed corresponding to each other, and an assembling method thereof.

### Description of Related Art

In conventional, the screws, the connecting structures, or the ultrasonic welding are provided to connect and assemble two objects, such as two cases of an electronic product. However, an additional tool (e.g. a screw driver) is needed to connect two objects with screws, and the fixing status and quality of the screws cannot be easily checked. This can decrease the production speed and production quality and increase the manufacturing cost. In addition, the general connecting structure usually comprises a recess disposed on the first object and a hook disposed on the second object. This design can fix two separated objects. However, the two fixed objects can be easily separated by applying two opposite external forces. Besides, the ultrasonic welding has the risk of failure, which may decrease the production yield.

Therefore, it is desired to provide a butting structure that can fix two objects for a long time and maintain the fastening effect under the influence of external forces.

### SUMMARY

An objective of this disclosure is to provide a butting structure that can maintain the fastening effect under the influence of external forces, thereby preventing the detachment of assembled objects. In addition, the additional tools (e.g. the ultrasonic welding or screws) are not needed for fixing the objects, so the connecting structure of this disclosure is more convenient and has lower cost.

The present disclosure provides a butting structure for fixing a first object and a second object. The butting structure comprises a first connecting portion and a second connecting portion. The first connecting portion is disposed on an inner surface of the first object. A leading angle is provided at a junction of a top surface and a first side of the first connecting portion. The top surface is a surface of the first connecting portion away from the first object, and the first side is a side of the first connecting portion facing the second object. An accommodation space is defined between the top surface and the inner surface of the first object. The second connecting portion is disposed on an inner surface of the second object, and comprises a bump and a horn structure. The bump is connected to the second object, and disposed corresponding to the accommodation space. The horn structure is connected to the second object, and disposed corresponding to the first connecting portion. A first gap is provided between the bump and the horn structure.

In one embodiment, the first connecting portion further comprises a contact block protruded from a part surface of the leading angle, and the contact block is disposed between the bump and the horn structure.

In one embodiment, the butting structure further comprises a hook portion disposed on the inner surface of the first object. The hook portion comprises an extension section, a hook section and a support rib. The extension section is connected to the first object. The hook section is disposed on one end of the extension section away from the first object, and a first included angle is defined between the hook section and the extension section. The support rib is connected to the first object and the extension section. A second gap is provided between the support rib and the hook section.

In one embodiment, the butting structure is configured for further fixing a third object. The third object is disposed between the first object and the second object, and a width of the second gap is configured corresponding to a thickness of an installation portion of the third object.

In one embodiment, the butting structure further comprises a limiting rib connected to the inner surface of the second object, and the limiting rib is correspondingly disposed between the second object and the hook portion.

In one embodiment, the horn structure comprises a connecting section and a boot section. The connecting section is connected to the second object, and the boot section is disposed on one end of the connecting section away from the second object. A second included angle is defined between the boot section and the connecting section.

In one embodiment, a third gap is provided between the boot section and the second object.

In one embodiment, a width of the third gap corresponds to a width between a second side of the first connecting portion and an end of the contact block close to the second object, and the second side is a side of the first connecting portion away from the second object.

In one embodiment, an interval is provided between the installation portion of the third object and the second side for accommodating the boot section.

To achieve the above objective, the present disclosure further provides an assembling method of the above-mentioned butting structure The assembling method comprises the steps of: assembling the installation portion of the third object to the second gap; assembling the second object to the first object, whereby the limiting rib contacts against the hook portion; contacting the bump against the first connecting portion for moving the first connecting portion from a first initial position to a first deformation position along a direction toward the interval; and embedding the bump into the accommodating space, whereby the first connecting portion moves from the first deformation position to the first initial position, meanwhile the contact block pushes the boot section from a second initial position to a second deformation position along a direction away from the bump, then the boot section moves from the second deformation position to the second initial position after the contact block is inserted into the third gap, and the horn structure engages with the first connecting portion so as to finish the assembling procedure.

As mentioned above, the butting structure of this disclosure can maintain the fastening effect under the influence of external forces, thereby preventing the detachment of assembled objects. In addition, the additional tools (e.g. the ultrasonic welding or screws) are not needed for fixing the objects, so the butting structure of this disclosure is more convenient and has lower cost.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing the first object, the second object and the third object, which are connected by the butting structure according to an embodiment of this disclosure;

FIG. 1B is a partial sectional view of the first object, the second object and the third object of FIG. 1A;

FIG. 1C is an exploded view of the first object, the second object and the third object of FIG. 1B;

FIG. 2A is a sectional view of the first object, the second object and the third object along the line A-A of FIG. 1A;

FIG. 2B is a schematic diagram showing a part of the first object, the second object and the third object before finishing the assembling procedure;

FIG. 3A is a sectional view of the first object, the second object and the third object along the line B-B of FIG. 1A; and

FIGS. 3B to 3D are schematic diagrams showing the first object, the second object and the third object during the assembling procedure.

### DETAILED DESCRIPTION OF THE DISCLOSURE

The present disclosure will be apparent from the following detailed description, which proceeds with reference to the accompanying drawings, wherein the same references relate to the same elements.

The butting structure of this disclosure can maintain the fastening effect for firmly fixing two objects under the influence of external forces, thereby preventing the detachment of assembled objects. In addition, the additional tools (e.g. the ultrasonic welding or screws) are not needed for fixing the objects, so the connecting structure of this disclosure is more convenient and has lower cost.

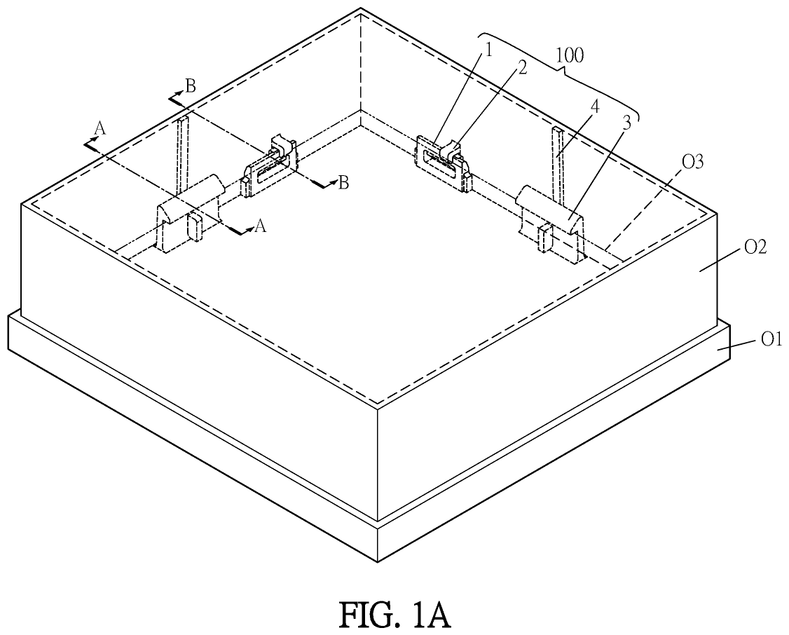

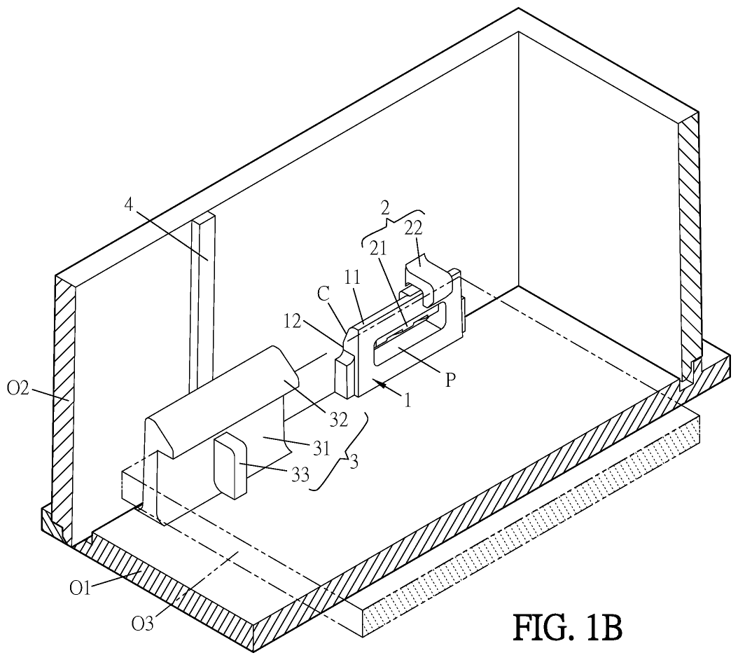

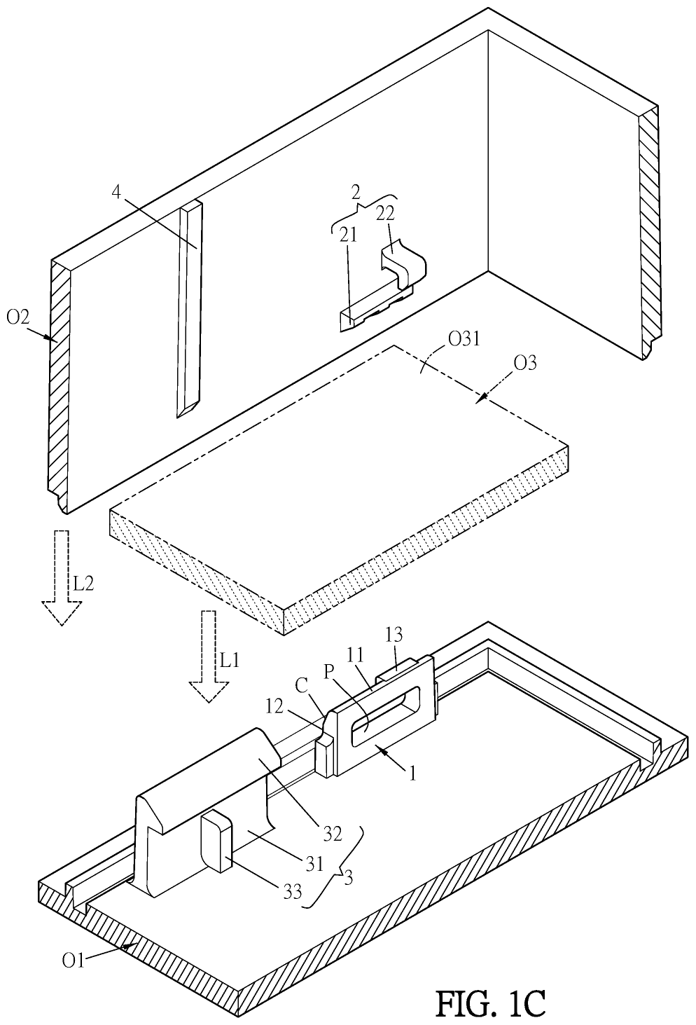

FIG. 1A is a schematic diagram showing the first object, the second object and the third object, which are connected by the butting structure according to an embodiment of this disclosure, FIG. 1B is a partial sectional view of the first object, the second object and the third object of FIG. 1A, and FIG. 1C is an exploded view of the first object, the second object and the third object of FIG. 1B. As shown in FIGS. 1A to 1C, a butting structure 100 of this disclosure is for fixing a first object O1 and a second object O2. In this embodiment, the butting structure 100 is further for fixing a third object O3, and the third object O3 is disposed between the first object O1 and the second object O2.

To be noted, the first object O1, the second object O2 and the third object O3 are shown by dotted lines in FIG. 1A. Besides, FIG. 1B only shows a part of the first object O1, the second object O2 and the third object O, and the object O3 is shown by dotted lines in FIG. 1B. Accordingly, the butting structure 100 can be clearly shown in FIGS. 1A and 1B. In this embodiment, for example, the first object O1, the second object O2 and the third object O3 are the upper case, the lower case, and the electronic board of an electronic device. The electronic device comprises two butting structures 100. However, the amount of the butting structures 100 can be adjusted according to the requirement of the user. In addition, the third object O3 can be another component inside the electronic device, such as, for example but not limited to, a fan, a memory, a mainboard, or the likes, and this disclosure is not limited thereto.

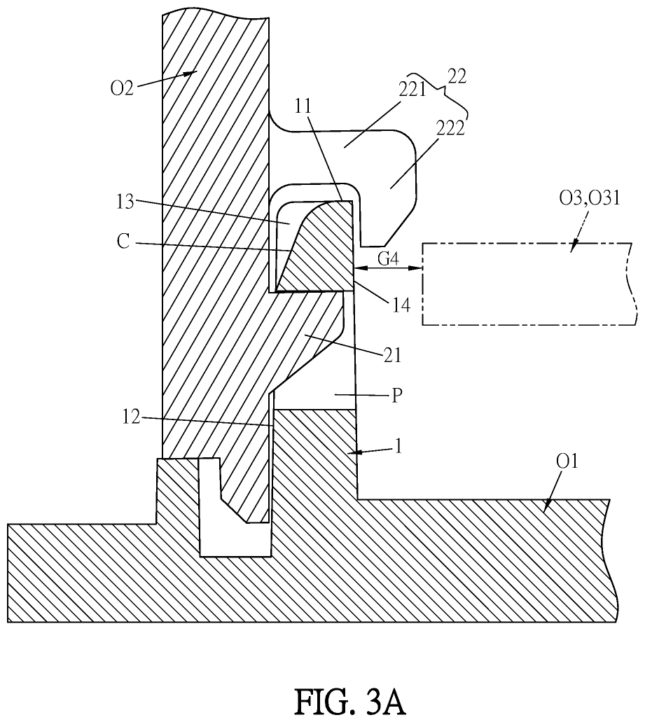

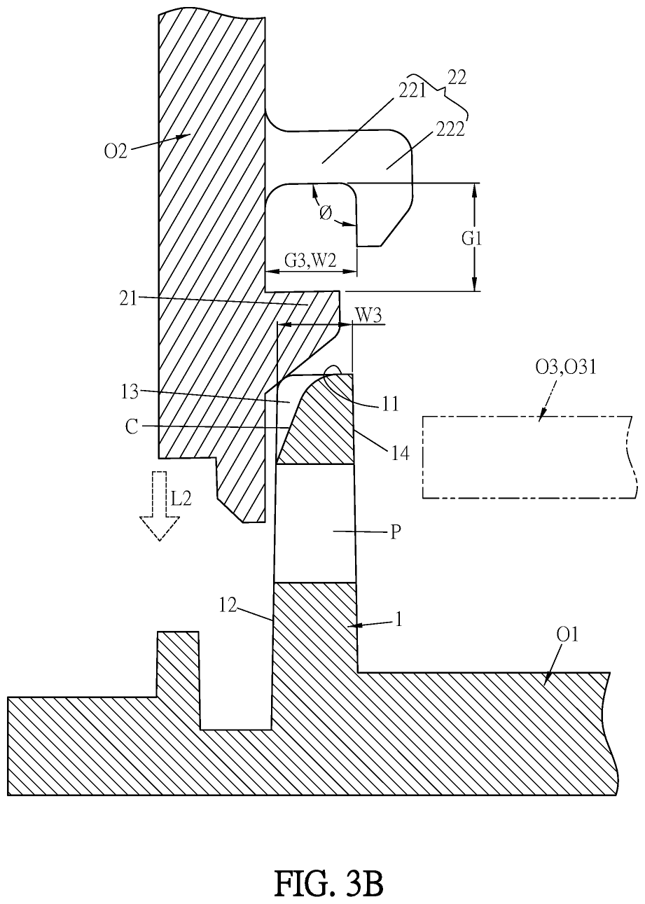

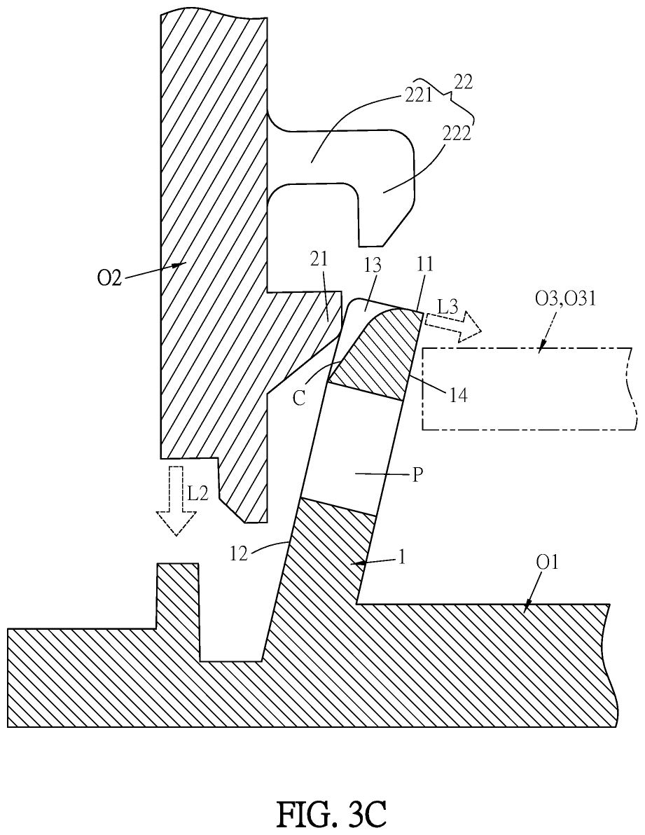

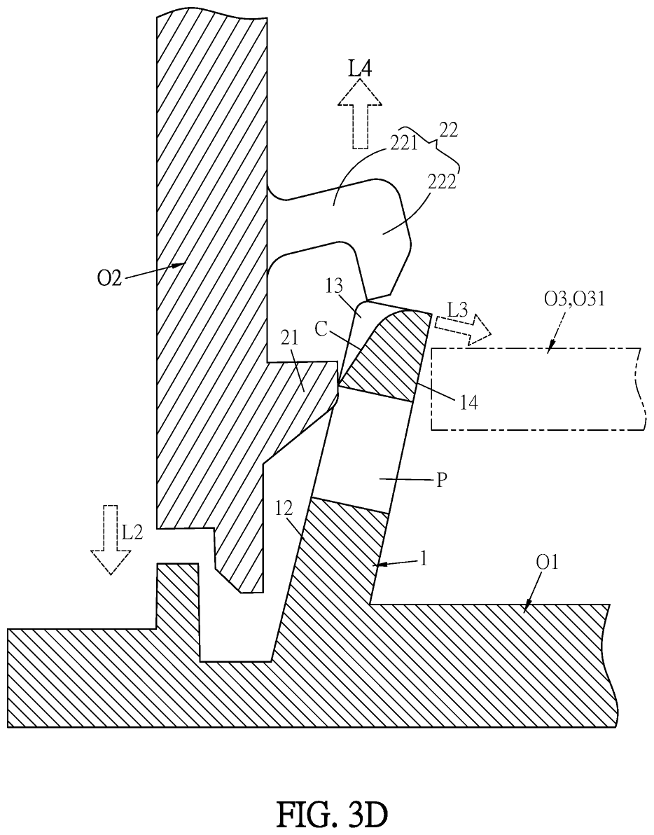

FIG. 3A is a sectional view of the first object, the second object and the third object along the line B-B of FIG. 1A. Referring to FIGS. 1B and 1C in view of FIG. 3A, the butting structure 100 comprises a first connecting portion 1 and a second connecting portion 2. The first connecting portion 1 is disposed on an inner surface of the first object O1. A leading angle C is provided at the junction of a top surface 11 and a first side 12 of the first connecting portion 1. The top surface 11 is a surface of the first connecting portion 1 away from the first object O1, and the first side 12 is a side of the first connecting portion 1 facing the second object O2. An accommodation space P is defined between the top surface 11 and the inner surface of the first object O1. The second connecting portion 2 is disposed on an inner surface of the second object O2. The second connecting portion 2 comprises a bump 21 and a horn structure 22. The bump 21 is connected to the second object O2, and disposed corresponding to the accommodation space P. The horn structure 22 is connected to the second object O2, and disposed corresponding to the first connecting portion 1.

With reference to FIGS. 3A and 1B, in this embodiment, the first connecting portion 1 further comprises a contact block 13 protruded from a part surface of the leading angle C. After the butting structure 100 is assembled, the contact block 13 is disposed between the bump 21 and the horn structure 22 (see FIG. 3A). Specifically, a first gap G1 is provided between the bump 21 and the horn structure 22 (see FIG. 3B), and the contact block 13 is disposed corresponding to the first gap G1.

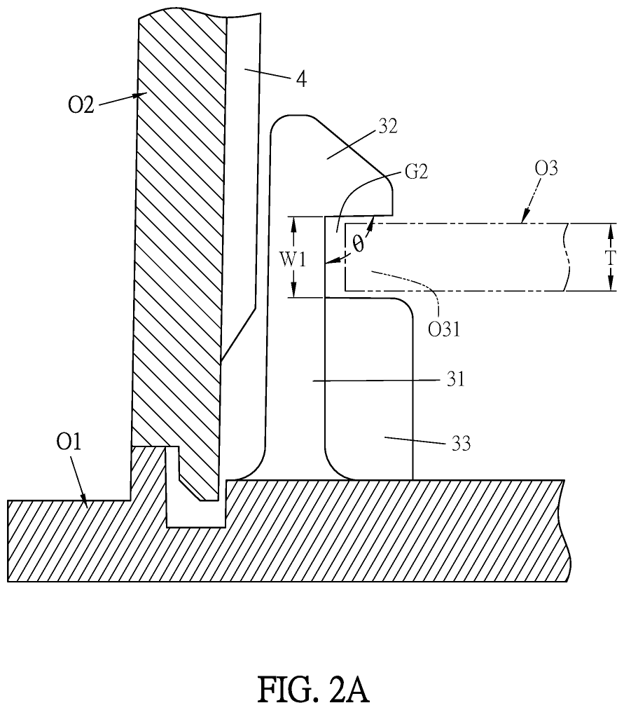

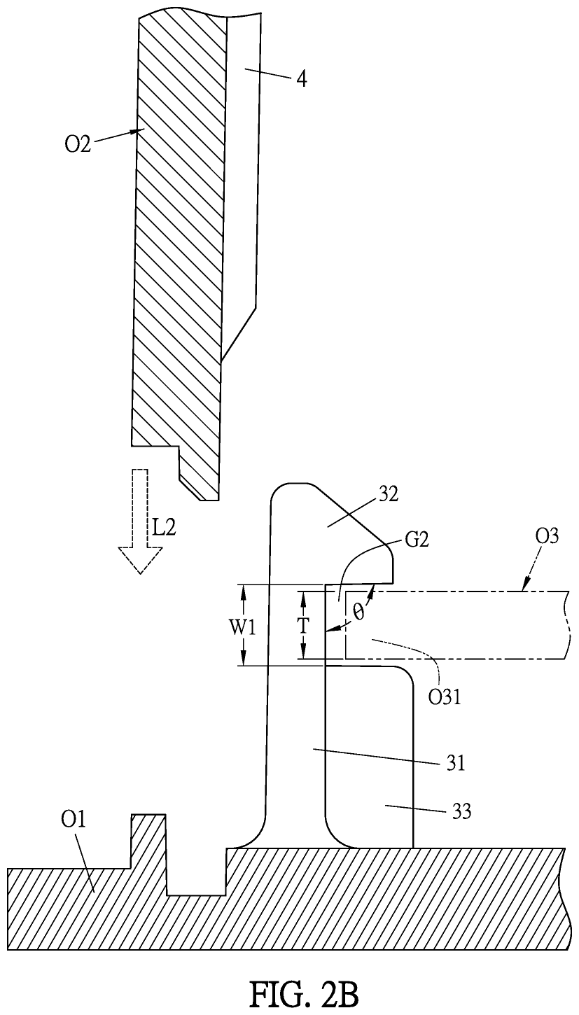

FIG. 2A is a sectional view of the first object O1, the second object O2, and the third object O3 along the line A-A of FIG. 1A. Referring to FIGS. 1B and 1C in view of FIG. 2A, in this embodiment, the butting structure 100 further comprises a hook portion 3 (see FIG. 1C) disposed on the inner surface of the first object O1. The hook portion 3 comprises an extension section 31, a hook section 32, and a support rib 33. The extension section 31 is connected to the first object O1. The hook section 32 is disposed on one end of the extension section 31 away from the first object O1, and a first included angle θ is defined between the hook section 32 and the extension section 31. The support rib 33 is connected to the first object O1 and the extension section 31. A second gap G2 is provided between the support rib 33 and the hook section 32. The width W1 of the second gap G2 is configured corresponding to the thickness T of an installation portion O31 of the third object O3. Specifically, since the width W1 of the second gap G2 is configured corresponding to the thickness T of the installation portion O31 of the third object O3, the installation portion O31 of the third object O3 can be tightly engaged between the support rib 33 and the hook section 32. The thickness T can be less than or equal to the width W1, as long as the installation portion O31 can be engaged between the support rib 33 and the hook section 32. In addition, the first included angle θ can be, for example but not limited to, 90 degrees, 60 degrees, 45 degrees, or 30 degrees, as long as the hook portion 3 can be disposed corresponding to the installation portion O31 of the third object O3. This disclosure is not limited thereto.

In this embodiment, the butting structure 100 further comprises a limiting rib 4 connected to the inner surface of the second object O2. The limiting rib 4 is correspondingly disposed between the second object O2 and the hook portion 3. Specifically, the limiting rib 4 is configured for limiting the displacement of the hook portion 3 in a direction toward the second object O2 (the leftward direction as shown in FIG. 2A), thereby firmly fixing the first object O1, the second object O2, and the third object O3.

Referring to FIGS. 3A and 3B, in this embodiment, the horn structure 22 comprises a connecting section 221 and a boot section 222. The connecting section 221 is connected to the second object O2, and the boot section 222 is disposed on one end of the connecting section 221 away from the second object O2. A second included angle ∅ is defined between the boot section 222 and the connecting section 221. To be noted, the second included angle ∅ can be, for example but not limited to, 90 degrees, 60 degrees, 45 degrees, or 30 degrees, as long as the horn structure 22 can be disposed corresponding to the first connecting portion 1.

In this embodiment, a third gap G3 is provided between the boot section 222 and the second object O2. The width W2 of the third gap G3 corresponds to the width W3 between a second side 14 of the first connecting portion 1 and an end of the contact block 13 close to the second object O2. The second side 14 is a side of the first connecting portion 1 away from the second object O2. Specifically, since the width W2 of the third gap G3 corresponds to the width W3 between the second side 14 of the first connecting portion 1 and the end of the contact block 13 close to the second object O2, the contact block 13 of the first connecting portion 1 can be tightly engaged within the third gap G3. The width W3 can be less than or equal to the width W2, as long as the contact block 13 of the first connecting portion 1 can be engaged between the boot section 222 of the horn structure 22 and the second object O2.

In this embodiment, an interval G4 is provided between the installation portion O31 of the third object O3 and the second side 14 for accommodating the boot section 222. Specifically, since the interval G4 is provided between the installation portion O31 of the third object O3 and the second side 14 of the first connecting portion 1 for accommodating the boot section 222 of the horn structure 22 of the second connecting portion 2, the installation portion O31 of the third object O3 can be interfered with the first connecting portion 1 of the first object O1 and the second connecting portion 2 of the second object O2, thereby firmly fixing the first object O1, the second object O2, and the third object O3.

The assembling procedure of the butting structure 100 will be described hereinafter with reference to FIGS. 3B to 3D. First, referring to FIGS. 1C and 2B, the third object O3 is disposed corresponding to the hook portion 3 along the arrow direction L1. Specifically, the installation portion O31 of the third object O3 contacts the hook section 32 of the hook portion 3, so that the hook section 32 can have a corresponding deformation with respect to the arrow direction L1. Afterwards, the installation portion O31 moves along the arrow direction L1 and then is engaged within the second gap G2 between the hook section 32 and the support rib 33. Then, the hook section 32 can recover to the initial position. In addition, the width W1 of the second gap G2 is configured corresponding to the thickness T of the installation portion O31 of the third object O3, so that the installation portion O31 of the third object O3 can be tightly engaged between the hook section 32 and the support rib 33 (see FIG. 2B).

Next, as shown in FIG. 1C, the second object O2 is disposed toward the first object O1 along the arrow direction L2, so that the first connecting portion 1 and the second connecting portion 2 of the butting structure 100 can be disposed corresponding to each other. In addition, the hook portion 3 and the limiting rib 4 of the butting structure 100 can also be disposed corresponding to each other. The configuration of the butting structure 100 will be described hereinafter in two parts.

Referring to FIGS. 2A and 2B, when the second object O2 moves toward the first object O1 along the arrow direction L2, the limiting rib 4 of the butting structure 100 can be correspondingly disposed between the inner surface of the second object O2 and the hook portion 3 of the butting structure 100 and then contact against the hook portion 3. The limiting rib 4 is configured for limiting the displacement of the hook portion 3 toward the second object O2 (the leftward direction of FIG. 2A), thereby firmly fixing the first object O1, the second object O2, and the third object O3.

With reference to FIGS. 3B to 3D, when the second object O2 moves toward the first object O1 along the arrow direction L2, the first connecting portion 1 and the second connecting portion 2 can be disposed corresponding to each other (as shown in FIG. 3B). Meanwhile, the second connecting portion 2 moves toward the first object O1 along the arrow direction L2, so that the bump 21 of the second connecting portion 2 contacts against the contact block 13 of the first connecting portion 1. Accordingly, the first connecting portion 1 can be deformed from a first initial position (the position as shown in FIG. 3B) to a first deformation position (the position as shown in FIG. 3C) along the arrow direction L3. Afterwards, the second connecting portion 2 moves toward the first object O1 along the arrow direction L2, so that the bump 21 of the second connecting portion 2 contacts against the contact block 13 of the first connecting portion 1, thereby pushing the contact block 13 to contact against the boot section 222 of the horn structure 22 of the second connecting portion 2. Accordingly, the boot section 222 of the horn structure 22 can be deformed from a second initial position (the position as shown in FIG. 3A) to a second deformation position (the position as shown in FIG. 3D) along the arrow direction L4. Finally, the second connecting portion 2 moves toward the first object O1 along the arrow direction L2, so that the bump 21 can be correspondingly engaged within the accommodating space P of the first connecting portion 1. Accordingly, the bump 21 does not contact against the contact block 13 of the first connecting portion 1, and the first connecting portion 1 can recover to approximate the first initial position (the position as shown in FIG. 3A). Then, the contact block 13 of the first connecting portion 1 enters the first gap G1 between the horn structure 22 and the bump 21 and the third gap G3 between the horn structure 22 and the second object O2, and the boot section 222 of the horn structure 22 of the second connecting portion 2 can recover the second initial position, thereby disposing the boot section 222 within the interval G4 between the third object O3 and the second side 14 of the first connecting portion 1.

Specifically, after the assembling procedure, the contact block 13 of the first connecting portion 1 is disposed in the first gap G1 between the bump 21 and the horn structure 22 of the second connecting portion 2, so that the contact block 13 can tightly connect the first connecting portion 1 and the second connecting portion 2, thereby fixing the first object O1 and the second object O2. The boot section 222 of the horn structure 22 is disposed in the interval G4, thereby limiting the displacement of the boot section 222 toward the third object O3 by the third object O3. This configuration can prevent the detachment of the boot section 222 and fix the first connecting portion 1, so that the first connecting portion 1, the second connecting portion 2 and the third object O3 can structurally interfere with each other and cannot have any relative movement. Accordingly, the first object O1, the second object O2 and the third object O3 cannot be easily detached under the influence of external forces after the assembling thereof.

In the above-mentioned embodiment, as shown in FIG. 1A, two butting structures 100 are configured for assembling the first object O1, the second object O2 and the third object O3, and each of the two butting structures 100 comprises a first connecting portion 1, a second connecting portion 2, a hook portion 3, and a limiting rib 4. To be noted, the above-mentioned embodiment is for an example but not to limit the disclosure. In other embodiments, the butting structure may comprise a first connecting portion 1 and a second connecting portion 2. In addition, the amount of the configured butting structures 100 can be adjusted according to the requirement of the user, and this disclosure is not limited thereto. For example, the first object O1, the second object O2 and the third object O3 can be assembled by four butting structures, wherein two butting structures 100 both comprise a first connecting portion 1, a second connecting portion 2, a hook portion 3, and a limiting rib 4, and rest two butting structures 100 both comprise a first connecting portion 1 and a second connecting portion 2 only. The butting structures can be configured symmetrically for further fixing the first object O1, the second object O2 and the third object O3. In addition, the hook portion 3 and the limiting rib 4 can be disposed at the left sides or right sides of the first connecting portion 1 and a second connecting portion 2, as long as the hook portion 3 and the limiting rib 4 are not connected with the first connecting portion 1 and a second connecting portion 2. Moreover, the butting structures 100 can be disposed on the inner surfaces of the first object O1 and the second object O2 by coupling, riveting, adhering, or integral formation.

In summary, the first connecting portion 1 of the first object O1 correspondingly connects to the second connecting portion 2 of the second object O2 and the installation portion O31 of the third object O3, and the hook portion 3 of the first object O1 correspondingly connects to the limiting rib 4 of the second object O2 and the installation portion O31 of the third object O3. Thus, the first object O1, the second object O2 and the third object O3 can be tightly connected together, so they cannot move toward any direction. Accordingly, the butting structure of this disclosure can maintain the fastening effect under the influence of external forces, thereby firmly fixing three objects and preventing the detachment of assembled objects. In addition, the additional tools (e.g. the ultrasonic welding or screws) are not needed for fixing the objects, so the butting structure of this disclosure is more convenient and has lower cost.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A butting structure for fixing a first object and a second object, comprising:
a first connecting portion disposed on an inner surface of the first object, wherein a leading angle is provided at a junction of a top surface and a first side of the first connecting portion, the top surface is a surface of the first connecting portion away from the first object, the first side is a side of the first connecting portion facing the second object, and an accommodation space is defined between the top surface and the inner surface of the first object; and
a second connecting portion disposed on an inner surface of the second object, wherein the second connecting portion comprises:
a bump connected to the second object, wherein the bump is disposed corresponding to the accommodation space, and
a horn structure connected to the second object, wherein the horn structure is disposed corresponding to the first connecting portion;
wherein a first gap is provided between the bump and the horn structure.

2. The butting structure according to claim 1, wherein the first connecting portion further comprises a contact block protruded from a part surface of the leading angle, and the contact block is disposed between the bump and the horn structure.

3. The butting structure according to claim 2, further comprising:
a hook portion disposed on the inner surface of the first object and comprising:
an extension section connected to the first object;
a hook section disposed on one end of the extension section away from the first object, wherein a first included angle is defined between the hook section and the extension section; and
a support rib connected to the first object and the extension section, wherein a second gap is provided between the support rib and the hook section.

4. The butting structure according to claim 3, wherein the butting structure is for further fixing a third object, the third object is disposed between the first object and the second object, and a width of the second gap is configured corresponding to a thickness of an installation portion of the third object.

5. The butting structure according to claim 4, further comprising:
a limiting rib connected to the inner surface of the second object, wherein the limiting rib is correspondingly disposed between the second object and the hook portion.

6. The butting structure according to claim 5, wherein the horn structure comprises:
a connecting section connected to the second object; and
a boot section disposed on one end of the connecting section away from the second object, wherein a second included angle is defined between the boot section and the connecting section.

7. The butting structure according to claim 6, wherein a third gap is provided between the boot section and the second object.

8. The butting structure according to claim 7, wherein a width of the third gap corresponds to a width between a second side of the first connecting portion and an end of the contact block close to the second object, and the second side is a side of the first connecting portion away from the second object.

9. The butting structure according to claim 8, wherein an interval is provided between the installation portion of the third object and the second side for accommodating the boot section.

10. An assembling method of the butting structure according to claim 7, comprising:
assembling the installation portion of the third object to the second gap;
assembling the second object to the first object, whereby the limiting rib contacts against the hook portion;
contacting the bump against the first connecting portion for moving the first connecting portion from a first initial position to a first deformation position; and
embedding the bump into the accommodating space, whereby the first connecting portion moves from the first deformation position to the first initial position, meanwhile the contact block pushes the boot section from a second initial position to a second deformation position along a direction away from the bump, then the boot section moves from the second deformation position to the second initial position after the contact block is inserted into the third gap, and the horn structure engages with the first connecting portion.

11. The assembling method according to claim 10, wherein a width of the third gap corresponds to a width between a second side of the first connecting portion and an end of the contact block close to the second object, and the second side is a side of the first connecting portion away from the second object.

12. The assembling method according to claim 11, wherein an interval is provided between the installation portion of the third object and the second side for accommodating the boot section, and when contacting the bump against the first connecting portion, the first connecting portion moves from the first initial position to the first deformation position along a direction toward the interval.
